(19) United States
(12) Patent Application Publication
(10) Pub. No.: US 2010/0165015 A1
(43) Pub. Date: Jul. 1, 2010

(54) System and Method for Selecting and Applying Appropriate Print Quality Defect Correction Technique to Compensate for Specified Print Quality Defect

(76) Inventors: Lucas David Barkley, Lexington, KY (US); Daniel Robert LaBar, Lexington, KY (US); Michael Anthony Marra, III, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/344,883

(22) Filed: Dec. 29, 2008

(51) Int. Cl. B41J 2/01

(52) U.S. Cl. 347/1

(57) ABSTRACT

A system for selecting and applying an appropriate print quality defect correction technique to compensate for specified print quality defects includes a printhead deployed to perform an operation that forms an image on a print medium sheet composed of multiple adjacently-positioned swaths of print, a sensor mechanism deployed to perform an operation that scans the image, detects the presence of specified print quality defects in the multiple adjacently-positioned swaths of print, and generates an output corresponding to the detected defect, and a control mechanism communicating with and controlling operations of the printhead and sensor mechanism and storing an algorithm that responds to the sensor mechanism output by analyzing and comparing the output with a stored threshold value and when the output exceeds the stored threshold value selecting and applying an appropriate print quality defect correction technique to the printhead that compensates for the detected print quality defect in the multiple adjacently-positioned swaths of print in subsequent images that are formed by the printhead.

### CROSS REFERENCES TO RELATED APPLICATIONS

None.

### BACKGROUND

1. Field of the Invention

The present invention relates generally to imaging systems, such as inkjet printers, and, more particularly, to a system and method for selecting and applying an appropriate print quality defect correction technique to compensate for a specified print quality defect.

2. Description of the Related Art

Stitching error primarily manifests itself in the printed output of inkjet printheads as horizontal offset between adjacent swaths. This is a print quality defect known as skew error which refers to offset from true vertical. Skew error occurs when the printhead is not oriented perpendicular to the direction of printhead carrier travel. There are three main sources for skew error, as mentioned in U.S. Pat. No. 6,350,004 assigned to the assignee of the present invention. (The disclosure of this patent is hereby incorporated herein by reference.) The first source is the printhead not correctly oriented on the ink reservoir; the second source is the printhead carrier angled as it is pulled from side to side during printing; and the third source is paper movement not perpendicular to the direction of travel of the printhead carrier. The effect of skew error is that features in a print swath are misaligned from true vertical and that features in a subsequent print swath do not line up with the features printed on a prior print swath. For example, when printing a vertical line, the bottom of a vertical line segment in the first swath is not centered on the top of the vertical line segment in the subsequent print swath when skew error is present. Stitching error is most noticeable in patterns of long vertical lines printed with a single color. If the amount of stitching error is large enough, normal human vision can detect a horizontal offset from the end of one print swath to the beginning of the next.

A first prior art approach to compensate for stitching error is disclosed in U.S. Pat. No. 5,956,055, assigned to the assignee of the present invention. (The disclosure of this patent is hereby incorporated herein by reference.) This first approach uses an alignment sensor to measure the amount of stitching offset or error and then to make a correction in a data formatter of a printer driver that controls printing of the image by the inkjet printer. The stitching error correction technique disclosed in this patent involves splitting the print swath into s number of smaller segments or sub-swaths and then horizontally shifting the print start position (by delaying or advancing the firing timing) of one of the two sub-swaths so that the horizontal offset is reduced between adjacent swaths, as seen in FIG. 1. The first dots of all sub-swaths will ideally land in the same horizontal location. In the ideal case, this splits the total uncorrected horizontal stitching offset or error (S_{U}) into s number of sections, thereby reducing the maximum offset by a factor of s.

With the swath-segmenting correction technique of the first approach, it might seem apparent that increasing the value for s would decrease the amount of stitching error after the correction has been applied (S_{C}). However, in actual practice, it becomes difficult to individually address and fire smaller and smaller sub-groups of ink-emitting orifices or nozzles. Also, S_{C} is very dependent on the horizontal print resolution (R_{H}, with units of μm per dot). If S_{U} is less than R_{H}, then there is no adjustment that can be made to improve stitching error (S_{C}=S_{U}). If S_{U} is greater than R_{H}, then in most cases S_{C} is between R_{H} and S_{U}/s. For a printer having a maximum horizontal print resolution of 21 μm per dot (1200 dpi), a stitching offset of this amount is in the range that the human eye can detect. So it would be advantageous to improve the stitching error correction. With the swath-segmenting technique, values of S_{C} equal to around 10 μm could theoretically be achieved by increasing the number of segments, s, from two to four and by decreasing the horizontal print resolution from 1200 dpi to 2400 dpi. Both of these goals are very difficult to attain, however.

A second prior art approach to compensate for stitching error is disclosed in U.S. Pat. No. 6,281,908, assigned to the assignee of the present invention. (The disclosure of this patent is hereby incorporated herein by reference.) This second approach involves another stitching error correction technique that is not as limited by print resolution and nozzle segment resolution as is the first approach. Based on a measurement of the stitching error (via an automatic alignment sensor, scanner or other suitable means), the start point of each swath is shifted so that the horizontal position of the first dot of the current swath (the head) is as close as possible to the last dot of the previous swath (the tail), as seen in FIG. 2. With this heat-to-tail (HTT) technique, the maximum—not minimum—value of S_{C} will approach R_{U}. Depending on the actual uncorrected stitching angle, S_{C} can even approach zero.

However, there are two potential drawbacks to use of the HTT correction technique of the second approach. The first drawback is that if many swaths are printed, the start position of swaths at the bottom of a page could be far away, horizontally, from the start position of swaths at the top of the page. This could create the appearance that the entire page is skewed. If, for instance, S_{U}=40 μm and there are 21 full swath heights on a 11 in. document, then the total horizontal shift in start position over the length of the page will be 0.031 in. If the specification or standard adopted for paper skew is 0.004 in./in. (or 0.044 in. for an 11 in. document), so even in an extreme case the proposed stitching correction technique will not by itself cause the (apparent) paper skew to be out of specification. However, it still would be beneficial to reduce the amount of apparent paper skew caused by the HTT correction technique.

The second drawback of the HTT correction technique may arise when multiple printhead are used, for example, separate chips for mono and color. If the relative difference between the stitching angles of the two printheads is great enough (especially if one angle is positive and the other negative, for instance), then the HTT correction technique could cause the horizontal alignment of the nozzles from the two printheads to grow further and further apart until normal human vision could detect a parallelism error, as depicted in FIG. 3. In order to improve print quality, it would be beneficial to reduce this parallelism error.

Thus, there is still a need for an innovation that will obviate these potential drawbacks to use of the prior art HTT correction technique.

### SUMMARY OF THE INVENTION

The present invention meets this need by providing an innovation that enhances capability to appropriately correct print quality defects, namely print skew, parallelism and white space errors, by improvement of selection and application of an appropriate print quality defect correction technique to compensate for a specified print quality defect in a manner that reduces such defects only to where they are imperceptible by normal human vision. This innovation thus eliminates adverse side effects from over-application of prior art correction techniques for skew, parallelism and white space errors between print swaths.

Accordingly, in an aspect of the present invention, a system for selecting and applying an appropriate print quality defect correction technique to compensate for a specified print quality defect includes at least one printhead deployed to perform an operation that forms an image on a print medium sheet composed of multiple adjacently-positioned swaths of print, a sensor mechanism deployed to perform an operation that scans the image, detects the presence of specified print quality defects in the multiple adjacently-positioned swaths of print, and generates an output corresponding to the detected print quality defect, and a control mechanism communicating with and controlling the operations performed by the printhead and the sensor mechanism and containing an algorithm that responds to the sensor mechanism output by (a) analyzing the output, (b) comparing the output with a threshold value and (c) when the output exceeds the threshold value, selecting and applying an appropriate print quality defect correction technique to the printhead that compensates for the presence of the detected print quality defect in the multiple adjacently-positioned swaths of print in subsequent images that are formed by the printhead. The appropriate correction technique is applied to the extent that the defect is reduced, but not eliminated, to below the threshold of perception by normal human vision. The algorithm also responds to the sensor mechanism output by not selecting and applying a print quality defect correction technique to the forming of an image when the output is less than the threshold value. The threshold value corresponds to the threshold of detection by normal human vision.

In another aspect of the present invention, a method for selecting and applying an appropriate print quality defect correction technique to compensate for a specified print quality defect includes forming an image on a print medium sheet composed of multiple adjacently-positioned swaths of print, scanning the image to detect the presence of specified print quality defects in the multiple adjacently-positioned swaths of print, generating an output corresponding to the detected print quality defect, and responding to the output corresponding to the detected print quality defect by employing an algorithm that (a) analyzes the output, (b) compares the output with a threshold value and (c) when the output exceeds the threshold value, selects and applies an appropriate print quality defect correction technique to the forming of an image that compensates for the presence of the detected print quality defect in the multiple adjacently-positioned swaths of print in subsequent images that are formed. Responding to the output includes selecting and applying an appropriate print quality defect correction technique to the forming of an image that compensates to reduce the print quality defect to the extent that the defect is not eliminated but only reduced below the threshold of perception by normal human vision. Responding to the output also includes not selecting and applying a print quality defect correction technique to the forming of an image when the output is less than the threshold value. The threshold value corresponds to the threshold of perception by normal human vision.

### BRIEF DESCRIPTION OF THE DRAWINGS

Having thus described the invention in general terms, reference will now be made to the accompanying drawings, which are not necessarily drawn to scale, and wherein:

FIG. 1 is a diagram of prior art in which adjacent print swaths in (a) embody uncorrected stitching error, and adjacent print swaths in (b) embody stitching error corrected in accordance with the prior art swath-segmenting correction technique.

FIG. 2 is a diagram of prior art in which adjacent print swaths in (a) embody uncorrected stitching error, and adjacent print swaths in (b) embody stitching error corrected in accordance with the prior art HTT correction technique.

FIG. 3 is a diagram of prior art in which adjacent print swaths in (a) embody no stitching error, adjacent print swaths in (b) made by multiple printheads embody stitching error, and adjacent print swaths in (c) embody stitching error corrected in accordance with the prior art HTT correction technique which produces a print quality parallelism defect.

FIG. 4 is a schematic representation of an exemplary embodiment of a prior art imaging system which can be operated in accordance with improvements provided by the system and method of the present invention.

FIG. 5 is a schematic representation of an exemplary embodiment of prior art printheads of the imaging system of FIG. 4 and their projection over a print medium sheet.

FIG. 6 is a diagram in which adjacent print images in (a) embody white space with no offset adjustment, and adjacent print images in (b) embody white space with offset adjustment by application of the prior art HTT correction technique.

FIG. 7 is a diagram in which adjacent print swaths in (a) embody stitching error corrected by application of the HTT correction technique in one printhead in accordance with improvements provided by the system and method of the present invention, adjacent print swaths in (b) embody stitching error corrected by application of the HTT correction technique in one printhead and the swath segmenting correction technique in the other printhead in accordance with improvements provided by the system and method of the present invention, and adjacent print swaths in (c) embody stitching error corrected by application of the HTT correction technique with start positions oppositely shifted in accordance with improvements provided by the system and method of the present invention.

FIG. 8 is a diagram in which adjacent print swaths in (a) have no stitching error, and adjacent print swaths in (b) embody stitching error corrected by application of HTT correction technique in one printhead and the swath segmenting correction technique in the other printheads in accordance with improvements provided by the system and method of the present invention.

FIGS. 9A & 9B together form a flowchart depicting an algorithm embodying improvements provided by the system and method of the present invention and employed in the prior art imaging system of FIG. 4 for selecting and applying an appropriate print quality defect correction technique to compensate for a specified print quality defect.

### DETAILED DESCRIPTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numerals refer to like elements throughout the views.

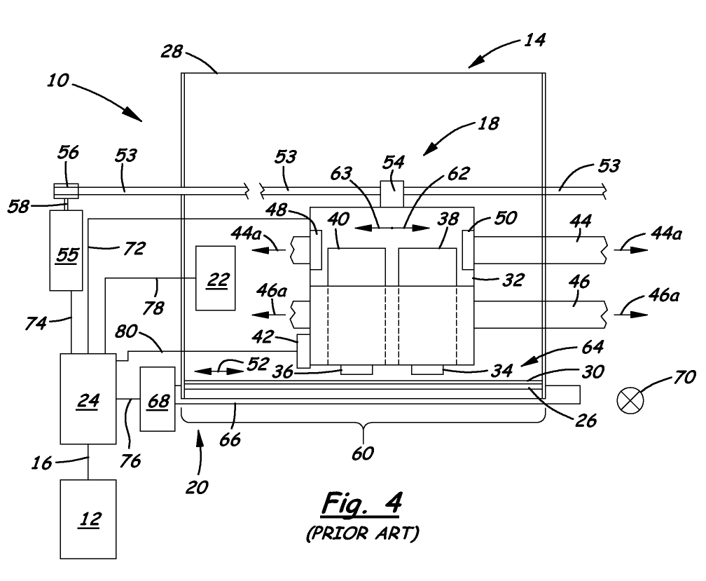

Referring now to FIG. 4, there is illustrated an exemplary embodiment of a prior art imaging system, generally designated 10, for employing improvements provided by the system and method of the present invention. The imaging system 10 includes a host computer 12 and an imaging apparatus 14, which, for example, may be in the form of a conventional inkjet printer. The host computer 12 may be separate from or a part of the imaging apparatus 14. The host computer 12 may be communicatively coupled to imaging apparatus 14 via a communications link 16. As used herein, the term “communications link” generally refers to structure that facilitates electronic communication between two components, and may operate using wired or wireless technology. The communications link 16 may be, for example, a direct electrical connection, a wireless connection, or a network connection. The host computer 12 may be, for example, a personal computer including a display device, an input device (e.g., keyboard), a processor, input/output (I/O) interfaces, memory, such as RAM, ROM, NVRAM, and a mass data storage device, such as a hard drive, CD-ROM and/or DVD units.

During operation, the host computer 12 includes in its memory a software program containing program instructions that function as a printer driver for the imaging apparatus 14. The printer driver, in communication with the imaging apparatus 14 via the communications link 16, for example, includes a half-toning unit and also a data formatter that places print data and print commands in a format that can be recognized by the imaging apparatus 14. In a network environment, communications between the host computer 12 and the imaging apparatus 14 may be facilitated via a standard communication protocol, such as the Network Printer Alliance Protocol (NPAP).

In the exemplary embodiment of FIG. 4, the imaging apparatus 14, in the form of an inkjet printer, includes a printhead carrier system 18, a feed roller unit 20, a sheet picking unit 22, a controller 24, a mid-frame 26 and a media source 28. The media source 28 is configured to receive a plurality of print medium sheets from which an individual sheet 30 is picked by the sheet picking unit 22 and transported to the feed roller unit 20, which in turn further transports the sheet 30 during an imaging operation. The sheet 30 may be, for example, plain paper, coated paper, photo paper, or transparency media.

The printhead carrier system 18 includes a printhead carrier 32 for mounting and carrying a color printhead 34 and/or a monochrome printhead 36. A color ink reservoir 38 is provided in fluid communication with the color printhead 34, and a monochrome ink reservoir 40 is provide in fluid communication with the monochrome printhead 36. Those skilled in the art will recognize that the color printhead 34 and color ink reservoir 38 may be formed as individual discrete units, or may be combined as an integral unitary printhead cartridge. Likewise, the monochrome printhead 36 and monochrome ink reservoir 40 may be formed as individual discrete units, or may be combined as an integral unitary printhead cartridge.

The printhead carrier system 18 further includes a reflectance sensor 42 attached to the printhead carrier 32. The reflectance sensor 42 may be used, for example, during scanning of a printhead alignment pattern. The reflectance sensor 42 may be, for example, a unitary optical sensor including a light source, such as a light emitting diode (LED), and a reflectance detector, such as a phototransistor. The reflectance detector is located on the same side of a media sheet as the light source. The operation of such sensors is well known in the art, and thus, will be discussed herein to the extent necessary to relate the operation of the reflectance sensor 42 to the operation of the present invention. For example, the LED of the reflectance sensor 42 directs light at a predefined angle onto a reference surface, such as the surface of the print medium sheet 30, and at least a portion of light reflected from the surface is receive by the reflectance detector of the sensor 42. The intensity of the reflected light received by the reflectance detector varies with the density of a printed image present on the sheet 30. The light received by the reflectance detector is converted to an electrical signal by the detector. The signal generated by the detector corresponds to the reflectivity from the print medium sheet 30, and the reflectivity of the printhead alignment pattern, scanned by the reflectance sensor 42.

The printhead carrier 32 is guided by a pair of guide members 44, 46, which may be, for example, in the form of guide rods. Each of the guide members 44, 46 includes a respective horizontal axis 44a, 46a. The printhead carrier 32 includes a pair of guide member bearings 48, 50, each of the guide member bearings 48, 50 including a respective aperture for receiving the guide member 44, 46. The horizontal axis 44a of the guide member 44 generally defines a bi-directional scan path 52, also referred to as main scan direction 52, for the printhead carrier 32. Accordingly, the bi-directional scan path 52 is associated with each of the printheads 34, 36 and the reflectance sensor 42.

The printhead carrier 32 is connected to a carrier transport belt 53 via a carrier drive attachment device 54. The carrier transport belt 53 is driven by a carrier motor 55 via a carrier pulley 56. The carrier motor 55 has a rotating carrier motor shaft 58 that is attached to the pulley 56. The carrier motor 55 can be, for example, a direct current (DC) motor or a stepper motor. At the directive of the controller 24, the printhead carrier 32 is transported in a reciprocating manner along the guide members 44, 46, and, in turn, along the main scan direction 52.

The reciprocation of the printhead carrier 32 transports the inkjet printheads 34, 36 and the reflectance sensor 42 across the print medium sheet 30 along main scan direction 52 to define a print/sense zone 60 of the imaging apparatus 14. The reciprocation of the printhead carrier 32 occurs in the main scan direction bi-directionally, and is also commonly referred to as the horizontal direction, including a left-to-right carrier scan direction 62 and a right-to-left carrier scan direction 63. Generally, during each scan of the printhead carrier 32 while printing or sensing, the print medium sheet 30 is held stationary by the feed roller unit 20. The mid-frame 26 provides support for the print medium sheet 30 when the sheet 30 is in the print/sense zone 60, and in part, defines a portion of a print medium path 64 of the imaging apparatus 14.

The feed roller unit 20 includes a feed roller 66 and corresponding index pinch rollers (not shown). The feed roller 66 is driven by a drive unit 68. The index pinch rollers apply a biasing force to hold the print medium sheet 30 in contact with the respective driven feed roller 66. The drive unit 68 includes a drive source, such as a stepper motor, and an associated drive mechanism, such as a gear train or belt/pulley arrangement. The feed roller unit 20 the print medium sheet 30 in a sheet feed direction 70, designated as an X in a circle to indicate that the sheet feed direction is out of the plane of FIG. 4 toward the reader. The sheet feed direction 70 is commonly referred to as the vertical direction, which is perpendicular to the horizontal bi-directional scan path 52, and, in turn, is perpendicular to the horizontal carrier scan directions 62, 63. Thus, with respect to the print medium sheet 30, carrier reciprocation occurs in a horizontal direction and media advance occurs in a vertical direction, and the carrier reciprocation is generally perpendicular to the media advance.

The controller 24 includes a microprocessor having an associated random access memory (RAM) and read only memory (ROM). The controller 24 is electrically connected and communicatively coupled to the printheads 34, 36 via a communications link 72, such as for example a printhead interface cable. The controller 24 is electrically connected and communicatively coupled to the sheet picking unit 22 via a communications link 78, such as for example an interface cable. The controller 24 also is electrically connected and communicatively coupled to the reflectance sensor 42 via a communications link 80, such as for example an interface cable.

The controller 24 executes program instructions to effect the printing of an image on the print medium sheet 30, such as for example, by selecting the index feed distance of the sheet 30 along the print medium path 64 as conveyed by the feed roller 66, controlling the acceleration rate and velocity of the printhead carrier 32, and controlling the operations of the printheads 34, 36, such as for example, by controlling the firing frequency of individual nozzles of the printhead 34 and/or printhead 36. As used herein, the term “firing frequency” refers to the frequency of successive firings of a nozzle of a printhead in forming adjacent dots on the same scan line of an image. In addition, the controller 24 executes instructions to the print printhead alignment patterns and to determine compensation values based on a reading of the printhead alignment patterns for reducing dot placement errors when printing, such as bi-directional printing, with one or both of the printheads 34, 36 in the imaging apparatus 14.

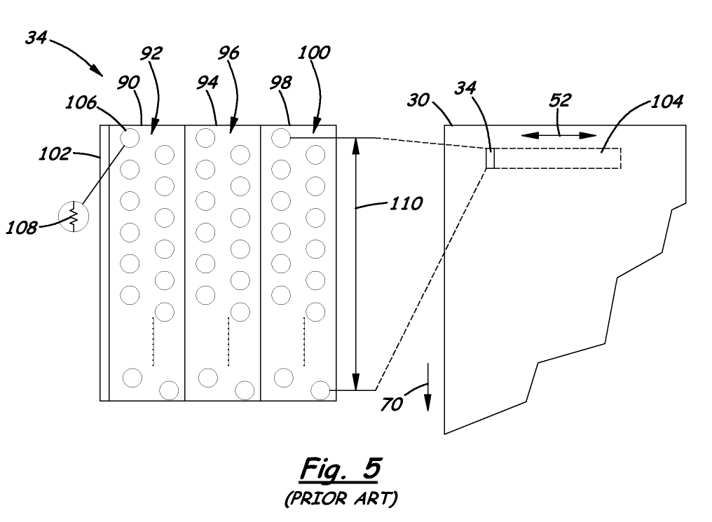

FIG. 5 shows one exemplary prior art configuration of the printhead 34, which includes a cyan nozzle plate 90 including a cyan nozzle array 92, a yellow nozzle plate 94 including a yellow nozzle array 96, and a magenta nozzle plate 98 including a magenta nozzle array 100, for respectively ejecting cyan (C) ink, yellow (Y) ink, and magenta (M) ink. In addition, the printhead 34 may include a memory 102 for storing information relating to the printhead 34 and/or imaging apparatus 14. For example, the memory 102 may be formed integral with the printhead 34, or may be attached to the color ink reservoir 38. For convenience, and ease of discussion, the memory 102 may also sometimes be referred to as printhead memory 102.

As further illustrated in FIG. 5, the printhead carrier 32 is controlled by the controller 24 to move the printhead 34 in a reciprocating manner in the main scan direction 52, with each left-to-right movement in the direction 62, or right-to-left movement in the direction 63, of the printhead carrier 32 along the main scan direction 52 over the print medium sheet 30 being referred to herein as a pass. The area traced by the printhead 34 over the print medium sheet 30 for a given pass will be referred to herein as the print swath, such as for example, swath 104 as shown in FIG. 5.

In the exemplary nozzle configuration for the inkjet printhead 34 shown in FIG. 5, each of the nozzle arrays 92, 96 and 100 include a plurality of ink jetting nozzles 106, with each ink jetting nozzle 106 having at least one corresponding heating element 108. The swath height 110 of swath 104 corresponds to the distance between the uppermost and lowermost of the nozzles within any array of nozzles of the printhead 34. The swath heights may be the same or different for the nozzle arrays.

As mentioned earlier, a print quality defect referred to as skew or stitching error primarily manifests itself in the images printed on the print medium sheet 30 by the inkjet printheads 34, 36 as horizontal offset between adjacent swaths 104. The horizontal offset refers to offset from true vertical. Slew or stitching error occurs when the printhead 34, 36 is not oriented perpendicular to the direction 62, 63 of travel of the printhead carrier 32. The causes may be that the printhead 34, 36 is not correctly oriented on the ink reservoir 38, 40, the printhead carrier 32 is angled as it is pulled from side to side during printing, and the movement of the sheet 30 is not perpendicular to the direction 62, 63 of travel of the printhead carrier 32. The effect of skew error is that features in a print swath 104 are misaligned from true vertical and that features in a subsequent print swath 104 do not line up with the features printed on a prior print swath 104. For example, when printing a vertical line, the bottom of a vertical line segment in the first swath 104 is not centered on the top of the vertical line segment in the subsequent print swath 104 when skew error is present. Stitching error is most noticeable in patterns of long vertical lines printed with a single color. If the amount of stitching error is large enough, normal human vision can perceive a horizontal offset from the end of one print swath to the beginning of the next.

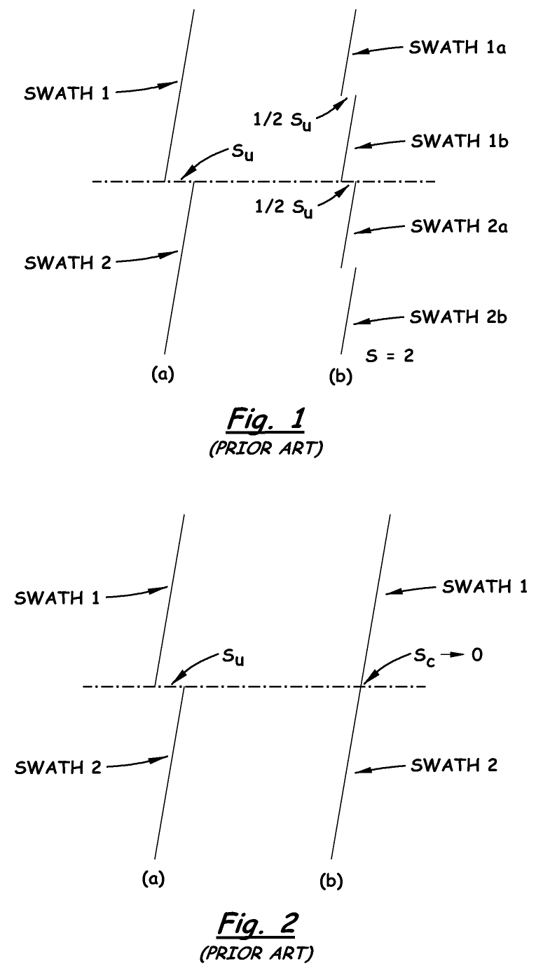

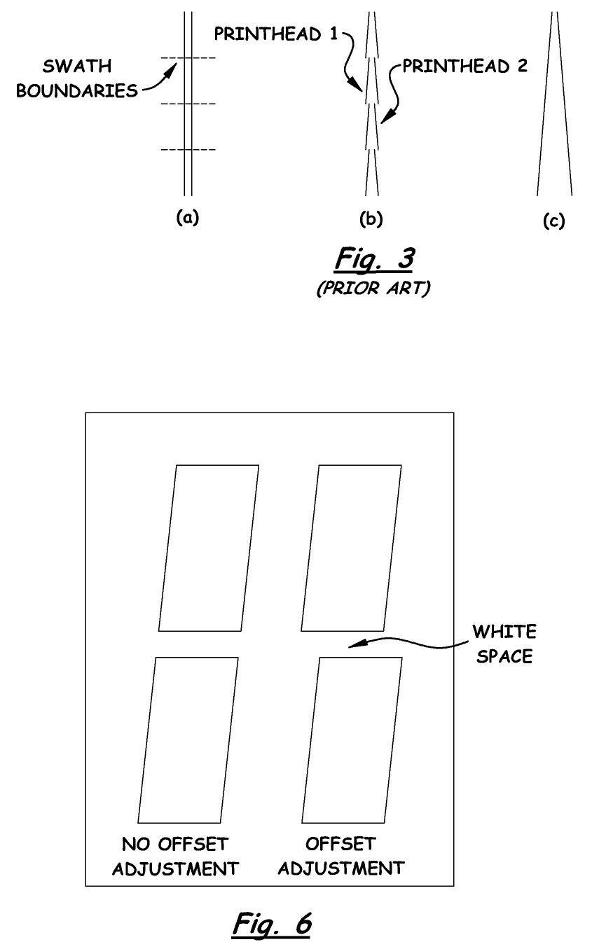

The system and method of the present invention are directed to making multiple improvements to selection and application of prior art print quality defect correction techniques, for example, the prior art swath-segmenting and HTT correction techniques described earlier and depicted in FIG. 2. These improvements will reduce perceived skew and parallelism errors between printheads that can be caused by application of the prior art HTT correction technique.

Application of the prior art HTT correction technique, without improvement in accordance with the system and method of the present invention, calls for shifting the start position of adjacent swaths so that the tail of a previous swath is as close as possible to the head of the next swath to it in order to achieve maximum reduction in the stitching offset error. The first improvement of the prior art HTT correction technique provided by the system and method of the present invention is to achieve an acceptable or minimum reduction, which is less than maximum reduction in the stitching offset error, to where the normal human vision cannot detect the remaining horizontal offset. At a normal reading or perception distance the accepted standard is that human vision can only detect a stitching error of about 20 μm or more. The data formatter of the print driver in the host computer 12 is adjusted in a manner well know to one of ordinary skill in the art to take advantage of this accepted standard, by being reset to reduce the offset shift in the swath start positions so that the stitching offset error is reduced to, for example, 15 μm, instead of to zero. If the uncorrected stitching offset was 30 μm, for example, and the corrected offset is now 15 μm, then the perceived skew and parallelism errors mentioned previously would only be reduced by a factor of two, compared to being reduced to zero in the case of application of the prior art HTT correction technique, and the stitching offset should still be substantially invisible to the user.

The second improvement of the prior art HTT correction technique provided by the system and method of the present invention takes advantage of the fact that most printed pages have at least some white space. Heretofore, the data formatter was adjusted in a manner well known to one of ordinary skill in the art to reset the horizontal start position offset to an optimal value (zero, for instance) every time there was a break in the image being printed, decreasing the perceived skew caused by application of the prior art HTT correction technique. However, if the stitching angle is large and there is a small amount of white space near the bottom of the page, resetting the horizontal start position for the next swath may cause a noticeable offset (similar to stitching error). For instance, as depicted in FIG. 6, the adjacent print images on the left embody white space with no offset adjustment and the small offset of adjacent portions of the images not noticeable, while the adjacent print images on the right embody white space with offset adjustment by application of the prior art HTT correction technique, causing the noticeable offset of adjacent portions of the images.

To counteract this, the second improvement of the prior art HTT correction technique provided by the system and method of the present invention adjusts the data formatter in a manner well know to one of ordinary skill in the art to reset the horizontal start position of the succeeding image only if the white space is more than a given threshold value. Thus, if the particular print job is a borderless photo, there is not likely to be any white space in the image. Also, if the image is skewed (due to application of the prior art HTT correction technique) for a borderless job, the amount of ink overspray must be increased in order to eliminate the potential for white spaces on the left and right edges of the paper. For these reasons, and since stitching error is normally not noticeable in a photograph (due to the large number of passes), it may be beneficial to reduce or turn off application of the prior art HTT correction technique for a borderless print job.

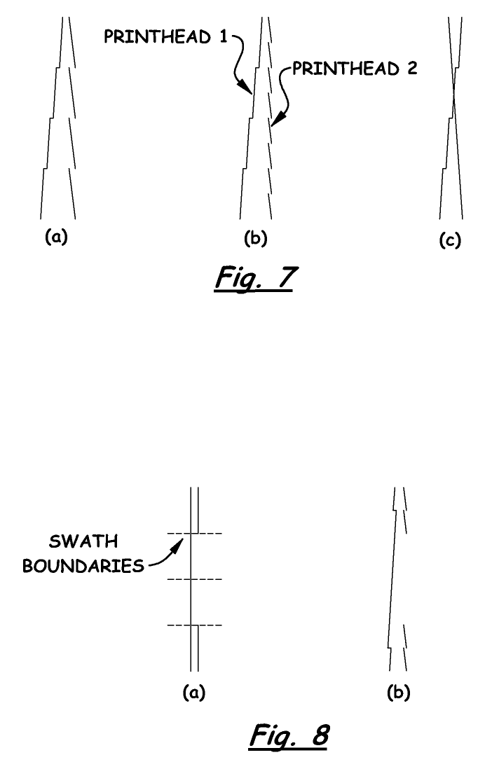

The third improvement of the prior art HTT correction technique provided by the system and method of the present invention addresses the parallelism error that can be caused by application of the prior art HTT correction technique. Some combinations of prior art stitching correction techniques to reduce these noticeable offsets constitute the third improvement provided by the system and method of the present invention. Examples of these combinations are depicted in FIG. 7. For example, in (a) of FIG. 7, when more than one printhead is used, the data formatter could selectively apply a separate prior art stitching error correction technique for each printhead, such as the prior art HTT correction technique in the printhead 1 and no correction technique in the printhead 2, as per the printhead labels set forth in (b) of FIG. 7. If the relative stitching error angle is larger than a given threshold value, the data formatter may reduce or turn off the prior art HTT correction technique for one or more printheads. Alternatively, the data formatter may apply the prior art HTT correction technique to one or more printheads and the prior art swath-segmenting correction technique to one or more printheads, as seen in (b) of FIG. 7. By way of example, the printhead 1 could be a mono printhead and the printhead 2 a color printhead. Those skilled in the art will recognize that there are many possible combinations of corrections (including no correction).

The fourth improvement of the prior art HTT correction technique provided by the system and method of the present invention is that, in order to minimize the non-parallelism effect without being forced to use a non-optimal stitching correction technique for one or more printheads, the data formatter shifts the initial print position for one printhead relative to the other printhead(s). If it is possible, before the print job begins the formatter could determine the size of each contiguous print block (i.e. a section that does not contain white space). Using the stitching angle for each printhead in the block, the formatter could calculate the maximum horizontal offset between each printhead at the bottom of the block (assuming the intended horizontal alignment occurs at the top). If it is not possible to determine the number and size of contiguous print blocks before the start of the print job, the formatter could shift the initial start position for each printhead so that the optimal horizontal alignment occurs as the middle of the page (in the vertical direction), as seen in (c) of FIG. 7, where stitching error is corrected by application of the prior art HTT correction technique to both printheads with start positions oppositely shifted.

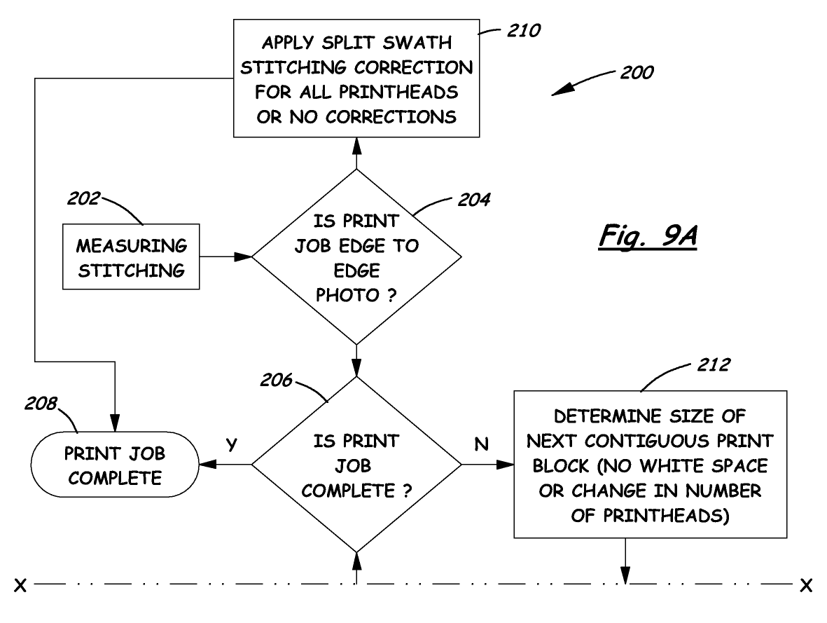

Lastly, the fifth improvement of the prior art HTT correction technique provided by the system and method of the present invention to minimize visible errors when multiple printheads are used addresses an approach to additional minimization of parallelism error. This can be achieved if the pattern to be printed has areas where only one printhead is used and other areas where multiple printheads are used, as seen in the desired pattern in (a) of FIG. 8. As depicted in (b) of FIG. 8, the formatter could perform the prior art HTT correction technique for the section where only the single printhead is used, and the prior art swath-segmenting correction technique (or no correction, or some other combination) in the sections where multiple printheads are used.

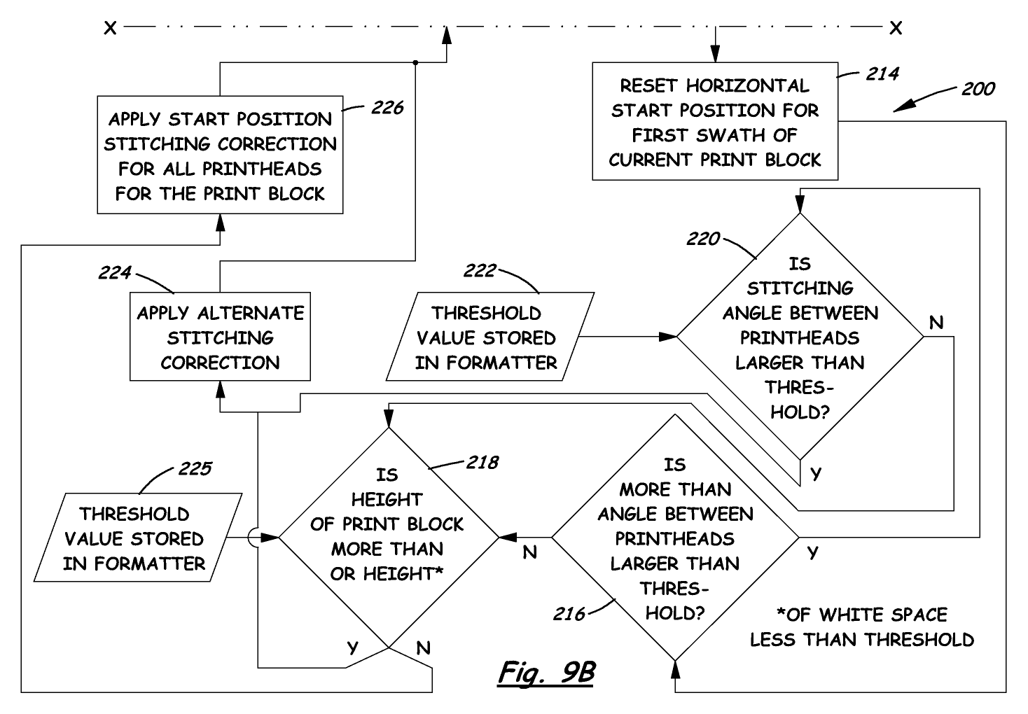

Turning now to FIGS. 9A & 9B, there is depicted a flowchart of an exemplary embodiment of an enhanced print quality defects correction algorithm 200 implemented by the system and method of the present invention for selecting and applying the appropriate prior art print quality defect correction technique to compensate for the different print quality defects. The overarching goal of the algorithm 200 is to appropriately correct print quality defects, meaning only to the extent that they are reduced below the threshold of perception of normal human vision and not necessarily eliminated. This way, adverse side effects from over-compensation or over-application of the prior art correction techniques is avoided.

The enhanced correction algorithm 200 begins, at block 202, with the alignment sensor 42 of the imaging system 10, under the control and direction of the controller 24 via communications link 80, measuring the amount of offset due to stitching or skew or white space present in adjacent multiple swaths 104 of an image printed on the print medium sheet 30 by a plurality of the color and/or mono printheads 34, 36 and the amount of white space at the margins of the sheet 30.

As per block 204, the algorithm 200 seeks a “yes” (Y) or “no” (N) answer to the question “Is print job edge to edge photo?”, in other words, what is the print job, that is, what type or kind of printed image is on the sheet 30? The intensity of the light reflected from various portions of the image on the sheet 30 (such as an alignment sheet used as part of an alignment procedure at installation), detected by the alignment sensor 42 and converted by the sensor 42 into output (electrical signals) communicated to the controller 24 is used by the controller 24 to determine whether the print job, that is, the image on the sheet 30, has little or no stitching angles and offsets and little or no white space. If it has little or no stitching angles and offsets or white space, the first and second improvements mentioned above mean that the data formatter directs that no correction technique be applied if stitching angles and offsets do not exceed a given threshold and the white space is less than a given threshold. If it has little or no white space, then it is a photograph and then the answer is Y. The given threshold in both cases corresponds to the threshold of perception of normal human vision of the offset and white space. Recall, that the overarching goal of the algorithm 200 is to appropriately correct a print quality defect on subsequent printed images, but not to entirely eliminate the defect, by reducing the defect only to the extent the defect is below the threshold of perception of normal human vision.

If the answer to the question in block 204 is N, the algorithm 200 branches to block 206 where the algorithm 200 seeks a Y or N answer to the question “Is print job complete?” which is determined by factors not part of the present invention. If the answer is Y, then the algorithm 200 branches to block 208 signifying that the print job is complete which ends the operation of the algorithm 200 for that particular sheet 30.

On the other hand, if the answer to the question in block 204 is Y, that is, the image is a photograph, the algorithm 200 branches to block 210. At block 210, the algorithm introduces the second improvement mentioned above meaning that the data formatter also directs that either no correction technique is to be applied in the case of a photograph or at most only a split swath stitching correction technique is to be applied for all printheads 34, 36. After this, the algorithm 200 branches to block 208 signifying that the print job is complete which ends the operation of the algorithm 200 for that particular sheet 30.

Returning now to block 206 where it will be recalled, the algorithm 200 seeks a Y or N answer to the question “Is print job complete?”. If the answer is N, then the algorithm 200 branches to block 212 where the algorithm 200 seeks to “Determine size of the next contiguous print block” (“contiguous” meaning that there is no white space or change in number of printheads). Once the operation of the algorithm 200 reaches block 212, the possibility of the image on the sheet 30 being a photograph has been eliminated and need not be tested during the remainder of the algorithm 200.

With the size of the next contiguous print block determined at block 212, the algorithm 200 proceeds to block 214, where in accordance with the first improvement mentioned hereinbefore, the horizontal start position for the first swath of the current print block is reset. After block 214, the algorithm 200 proceeds to block 216 where the question asked “Is more than one printhead used in the print block?”. Whether the answer is Y or N, the algorithm 200 will proceed to the same block 218, directly if the answer is N and indirectly if the answer is Y. If there is not plural printheads used in the print block, then the algorithm 200 proceeds next to block 218. If there is plural printheads used in the print block, the algorithm 200 addresses the question in block 220 “Is stitching angle between the printheads larger than threshold?” and compares the stitching angle of printheads with the given threshold value stored in the formatter as per block 222. If the stitching angle of the printheads is larger than the given threshold value, the algorithm 200 proceeds to block 224 which is after block 218. The third improvement mentioned hereinabove is applied at block 224. If only one printhead was used in the print block, the answer to block 216 was N and the algorithm proceeded to block 218.

So whether the answer to the question of block 216 was Y or N, the algorithm 200 arrives at the same location, block 218, to address the question “Is height of print block more than threshold or height of white space less than threshold?” and compare the heights with the threshold values stored in the formatter, as per block 225. If the answer is Y, then at block 224 the algorithm 200 directs the controller 24 to “apply an alternate stitching correction”, whereas if the answer is N, then at block 226 the algorithm 200 directs the controller 24 to “apply start position stitching correction for all printheads for the print block”. These involve the third, fourth and fifth improvements described hereinbefore.

The algorithm 200 proceeds from both blocks 224, 226 to an earlier block 206 where the question “Is print job completed?” is asked. The algorithm branches to block 208 where the algorithm terminates for the current sheet if the answer is Y. The algorithm branches to block 212 where the algorithm does through at least another iteration of from block 212 to blocks 224, 226 before returning to block 206, if the answer is N.

To recap, other than choosing not to apply any adjustment or correction technique, the prior art correction technique choices are swath-segmenting and simple HTT. The choices of improved correction techniques are partial HTT, white space reset, and printhead start position offset. As to when to use any of these correction techniques, a representative example of a set of the guidelines may be as follows: (1) Use simple HTT when correction is less than 45 μm per ½ in. swath (i.e., accumulated error down an 11 in. page would be less than 1 mm). Alternatively, the range of correctable error could be expanded by using partial HTT (i.e., set range to less than 60 μm per ½ in., and adjust up to 45 μm per ½ in., maintaining less than 1 mm total accumulated error); (2) Reset white space whenever possible. For instance, if the page is divided into 2 areas of print with white space in between, each area would be printed using simple HTT, with some amount of reset in position between the areas (the amount is likely proportional to the amount of white space, so that if the white space is small there would only be a small shift from the bottom of the first area to the top of the second area. Taking this to the extreme, for text printing where swath boundaries are always in white space, this reverts to no adjustment at all; (3) Two printhead HTT adjustment if total accumulated error down the page between the two printheads is less than some predetermined limit such as 0.5 mm. For example, if printhead #1 requires 40 μm adjustment per ½ in., and printhead #2 requires 20 μm per ½ in. in the same direction as printhead #1, then the total accumulated error down an 11 in. page would (40 μm−20 μm)*(11/0.5)=0.44 mm. Conversely, if printhead #2 required a 20 μm adjustment in the opposite direction to printhead #1, the total accumulated error would be (40 μm+20 μm)*(11/0.5)=1.32 mm, which exceeds the threshold and another method should be used; and (4) Use a hybrid HTT and swath segmenting for multiple printheads where the errors would not satisfy the scenarios detailed above.

In summary, the system and method of the present invention are directed to the following enhancements of the prior art stitching correction techniques which result from use of the above-described algorithm: (1) reducing perceived skew (for one or more printheads) and parallelism errors between printheads by setting the HTT-corrected stitching error to an imperceptible level (instead of the optimal level for reducing stitching); (2) reducing perceived skew when there is white space in the print image by resetting the print start position, by optionally turning off or reducing perceived skew when the stitching angle is more than a threshold and the white space is less than a threshold or by optionally turning off or reducing perceived skew when the print job has little or no white space (e.g. a photo); (3) reducing parallelism error when more than one printhead is used and the relative stitching angle is more than a threshold by selectively applying separate stitching corrections for each printhead; (4) reducing parallelism error when more than one printhead is used and the relative stitching angle is more than a threshold by shifting the start position of one or more of the printheads relative to the other(s); and (5) reducing parallelism error when more than one printhead is used, the relative stitching angle is more than a threshold, and the image transitions between requiring multiple printheads and a single printhead by selectively applying separate stitching corrections for each block for each printhead.

The foregoing description of several embodiments of the invention has been presented for purposes of illustration. It is not intended to be exhaustive or to limit the invention to the precise forms disclosed, and obviously many modifications and variations are possible in light of the above teaching. It is intended that the scope of the invention be defined by the claims appended hereto.

What is claimed is:

1. A system for selecting and applying the appropriate print quality defect correction technique to compensate for specified print quality defects, comprising:
at least one printhead deployed to perform an operation that forms an image on a print medium sheet composed of multiple adjacently-positioned swaths of print;
a sensor mechanism deployed to perform an operation that scans the image, detects the presence of specified print quality defects in the multiple adjacently-positioned swaths of print, and generates an output corresponding to a detected print quality defect; and
a control mechanism communicating with and controlling the operations performed by said printhead and said sensor mechanism and containing an algorithm that responds to the sensor mechanism output by
(a) analyzing the output,
(b) comparing the output with a threshold value, and
(c) when the output exceeds the threshold value, selecting and applying an appropriate print quality defect correction technique to said printhead that compensates for the presence of the detected print quality defect in the multiple adjacently-positioned swaths of print in subsequent images that are formed by the printhead.

2. The system of claim 1 wherein said control mechanism applies the appropriate print quality defect correction technique to said printhead to the extent that the defect is not eliminated but only reduced below the threshold of perception by normal human vision.

3. The system of claim 1 wherein said at least one printhead further comprises first and second pluralities of printheads deployed to perform operations that form the image on the print medium sheet composed of the multiple adjacently-positioned swaths of print.

4. The system of claim 3 wherein said appropriate print quality defect correction technique selected and applied to at least one printhead of one of said first and second pluralities is a head-to-tail correction technique.

5. The system of claim 4 wherein said appropriate print quality defect correction technique selected and applied to at least one printhead of the other of said first and second pluralities is no correction technique.

6. The system of claim 4 wherein said appropriate print quality defect correction technique selected and applied to at least one printhead of the other of said first and second pluralities is a swath-segmenting correction technique.

7. The system of claim 3 wherein said appropriate print quality defect correction technique selected and applied to at least one printhead of the other of said first and second pluralities is swath-segmenting correction technique.

8. The system of claim 7 wherein said appropriate print quality defect correction technique selected and applied to at least one printhead of the other of said first and second pluralities is no correction technique.

9. The system of claim 3 wherein said first and second pluralities of printheads either differ in number of printheads or have at least some printheads that differ in color.

10. The system of claim 3 wherein said appropriate print quality defect correction techniques selected and applied to at least one printhead of each of said first and second pluralities are either head-to-tail or swath-segmenting correction techniques.

11. A method for selecting and applying the appropriate print quality defect correction technique to compensate for the different print quality defects, comprising:
forming an image on a print medium sheet composed of multiple adjacently-positioned swaths of print;
scanning the image to detect the presence of specified print quality defects in the multiple adjacently-positioned swaths of print;
generating an output corresponding to the detected print quality defect; and
responding to the output corresponding to the detected print quality defect by employing an algorithm that
(a) analyzes the output,
(b) compares the output with a threshold value, and
(c) when the output exceeds the threshold value, selects and applies an appropriate print quality defect correction technique to said forming of an image that compensates for the presence of the detected print quality defect in the multiple adjacently-positioned swaths of print in subsequent images that are formed.

12. The method of claim 11 wherein said responding to the output includes selecting and applying an appropriate print quality defect correction technique to said forming of an image that compensates to reduce the print quality defect to the extent that the defect is not eliminated but only reduced below the threshold of perception by normal human vision.

13. The method of claim 11 wherein said responding to the output also includes not selecting and applying a print quality defect correction technique to said forming of an image.

14. The method of claim 11, wherein said threshold value corresponds to the threshold of perception of normal human vision.

15. The method of claim 11 wherein said forming an image includes operating at least one printhead and applying a print quality defect correction technique to adjust the operation of said printhead to compensate for the presence of a detected print quality defect in the multiple adjacently-positioned swaths of print produced by said printhead.

16. The method of claim 11 wherein said forming an image includes operating first and second pluralities of printheads and applying a head-to-tail correction technique to adjust the operation of at least one printhead of one of said first and second pluralities to compensate for the presence of a detected print quality defect in the multiple adjacently-positioned swaths of print produced by said printheads.

17. The method of claim 16 wherein said forming an image further includes applying no correction technique to at least one printhead of the other of said first and second pluralities.

18. The method of claim 11 wherein said forming an image includes operating first and second pluralities of printheads and applying a swath-segmenting correction technique to adjust the operation of at least one printhead of one of said first and second pluralities to compensate for the presence of a detected print quality defect in the multiple adjacently-positioned swaths of print produced by said printheads.

19. The method of claim 18 wherein said forming an image further includes applying no correction technique to at least one printhead of the other of said first and second pluralities.

20. The method of claim 18 wherein said forming an image further includes applying a head-to-tail correction technique to adjust the operation of at least one printhead of the other of said first and second pluralities to compensate for the presence of a detected print quality defect in the multiple adjacently-positioned swaths of print produced by said printheads.
